(19) United States
(12) Patent Application Publication
(10) Pub. No.: US 2024/0386502 A1
(43) Pub. Date: Nov. 21, 2024

(54) DYNAMIC REAL TIME INSURANCE QUOTES AND COMMERCE CONTRACTS

(71) Applicant: INTERNATIONAL BUSINESS MACHINES CORPORATION, ARMONK, NY (US)

(72) Inventors: Hamid Majdabadi, OTTAWA (CA); Jeremy R. Fox, Georgetown, TX (US); Louis P. Gomes, Poughkeepsie, NY (US); Terri Vanessa Dillon, Redondo Beach, CA (US); Tiberiu Suto, Franklin, NY (US)

(21) Appl. No.: 18/320,497

(22) Filed: May 19, 2023

(51) Int. Cl. G06Q 40/08

(52) U.S. Cl. CPC G06Q 40/08

(57) ABSTRACT

A method, computer system, and a computer program product for insurance premium determinations is provided. The present invention may include generating a baseline insurance coverage policy for an object. The present invention may include presenting a user with the baseline insurance coverage policy prior to an operation of the object. The present invention may include monitoring the operation of the object by the user.

### BACKGROUND

The present invention relates generally to the field of computing, and more particularly to micro-insurance premium determinations.

Today, one can obtain insurance coverage for objects and/or entities operated by a user. However, the premiums for the insurance may not be aligned with various risk profiles of the user and/or a user's experience. Often times the premium values paid do not reflect either the expertise of the user, frequency in which the user operates an object, nor the conditions in which the object may be operated. Micro-insurance may be a type of insurance designed to make insurance products more affordable based on specific needs of a user. Micro-insurance may be utilized in various situations, such as, but not limited to, short time period events, one-time events, specific needs, amongst other various situations. Currently, micro-insurance premium values may be determined by predicting the health of an object and/or entity over a specified time period. These health predictions of the object and/or entity to be covered by the micro-insurance may be mapped to a financial value of the object and/or entity to determine an insurance premium value for the specified period of time.

Accordingly, a method of determining appropriate micro-insurance premium values for objects operated by a user that considers a plurality of factors specific to both the user and the object are required.

### SUMMARY

Embodiments of the present invention disclose a method, computer system, and a computer program product for micro-insurance premium determinations. The present invention may include generating a baseline insurance coverage policy for an object. The present invention may include presenting a user with the baseline insurance coverage policy prior to an operation of the object. The present invention may include monitoring the operation of the object by the user.

In another embodiment, the method may include adjusting the micro-insurance premium value of the baseline insurance coverage policy based on data received during the monitoring of the operation of the object by the user.

In a further embodiment, the method may include presenting the user with a baseline insurance coverage policy in a micro-insurance user interface, wherein the micro-insurance user interface includes a user profile of the user, and wherein the user profile includes a record of one or more recommended learning programs previously completed by the user.

In yet another embodiment, the method may include retraining an agent utilized in generating the baseline insurance coverage policy, wherein the agent is retrained using one or more reinforcement learning methods based on data received during the monitoring of the operation of the object by the user.

In addition to a method, additional embodiments are directed to a computer system and a computer program product for generating user specific baseline insurance coverage policies for the operation of an object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for insurance premium determinations according to at least one embodiment.

### DETAILED DESCRIPTION

The following described exemplary embodiments provide a system, method and program product for insurance premium determinations. As such, the present embodiment has the capacity to improve the technical field of micro-insurance coverage, digital twin technology, and reinforcement learning methods by generating user specific baseline insurance coverage policies for the operation of an object. More specifically, the present invention may include generating a baseline insurance coverage policy for an object. The present invention may include presenting a user with the baseline insurance coverage policy prior to an operation of the object. The present invention may include monitoring the operation of the object by the user.

As described previously, today, one can obtain insurance coverage for objects and/or entities operated by a user. However, the premiums for the insurance may not be aligned with various risk profiles of the user and/or a user's experience. Often times the premium values paid do not reflect either the expertise of the user, frequency in which the user operates an object, nor the conditions in which the object may be operated. Micro-insurance may be a type of insurance designed to make insurance products more affordable based on specific needs of a user. Micro-insurance may be utilized in various situations, such as, but not limited to, short time period events, one-time events, specific needs, amongst other various situations. Currently, micro-insurance premium values may be determined by predicting the health of an object and/or entity over a specified time period. These health predictions of the object and/or entity to be covered by the micro-insurance may be mapped to a financial value of the object and/or entity to determine an insurance premium value for the specified period of time.

Accordingly, a method of determining appropriate micro-insurance premium values for objects operated by a user that considers a plurality of factors specific to both the user and the object are required.

Therefore, it may be advantageous to, among other things, generate a baseline insurance coverage policy for the operation of an object, present a user with the baseline insurance coverage policy prior to an operation of the object, and monitoring the operation of the object by the user.

According to at least one embodiment, the present invention may improve generating a baseline insurance coverage policy for the operation of an object by training an agent via trial-and-error interactions using different Reinforcement Learning (RL) methods in order to provide at least, specific incentives, recommendations, and/or premium values to the user.

According to at least one embodiment, the present invention may improve generating a baseline insurance coverage policy for the operation of an object by simulating a plurality of unique scenarios using a digital twin represented of the object being covered by the baseline insurance coverage policy using one or more forecasting machine learning models. This may enable the invention to simulate the particular capabilities of the object in a plurality of conditions representative of the conditions in which the user may be operating the object which may enable the baseline insurance coverage policy for the operation of the object to be generated specifically to the user, the object, and the conditions in which the object may be operated.

According to at least one embodiment, the present invention may improve insurance coverage policy transparency by presenting the baseline insurance coverage policy in a micro-insurance user interface. The micro-insurance user interface includes a profile of the user which may be utilized in recording completed recommended learning programs which may directly impact a micro-insurance premium value.

According to at least one embodiment, the present invention may improve information available to the user during the operation of the object such as a heatmap which may static and/or dynamically change in real time. The heatmap displayed to the user may utilize visual cues such as colors, symbols, and/or warnings in communicating information about an operation area to the user. The one or more visual cues may be related to, but are not limited to, hazards, overhead power lines, trees, buildings, object concentrations, valleys, crosswinds, amongst other hazards which may have been derived from the crowdsources data relating to the operation of the same and/or similar objects and/or entities by other users

According to at least one embodiment, the present invention may improve future baseline insurance coverage policies by providing one or more recommendations to the user may include incentives and/or other recommendations, such as, but not limited to, recommended learning programs, to the user which may reduce the micro-insurance premium value to the user.

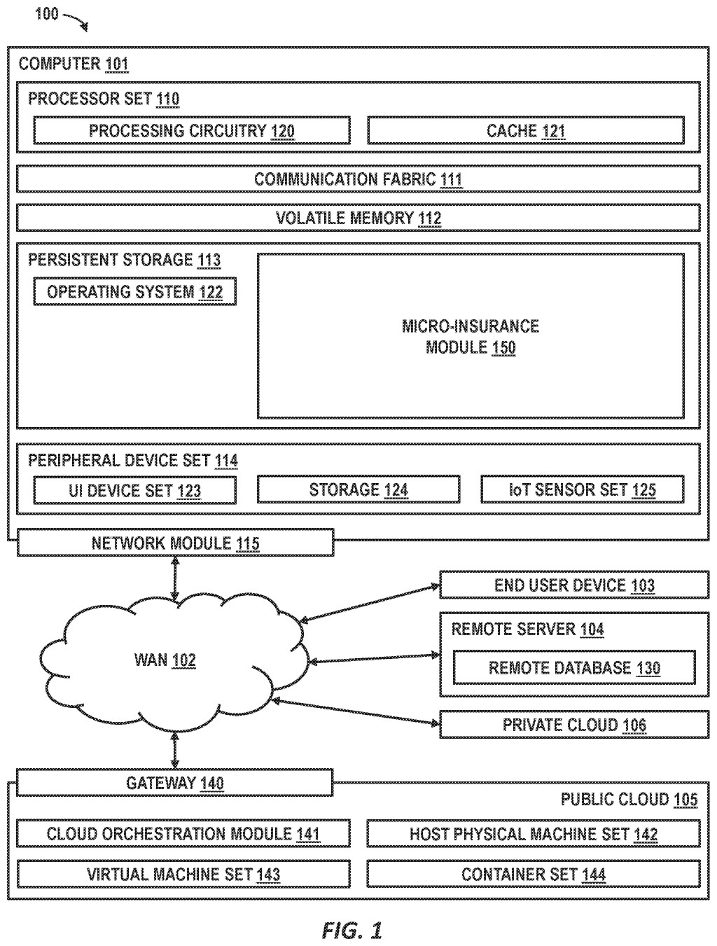

Referring to FIG. 1, Computing environment 100 contains an example of an environment for the execution of at least some of the computer code involved in performing the inventive methods, such as generating user specific baseline insurance coverage policies for the operation of an object using a micro-insurance module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

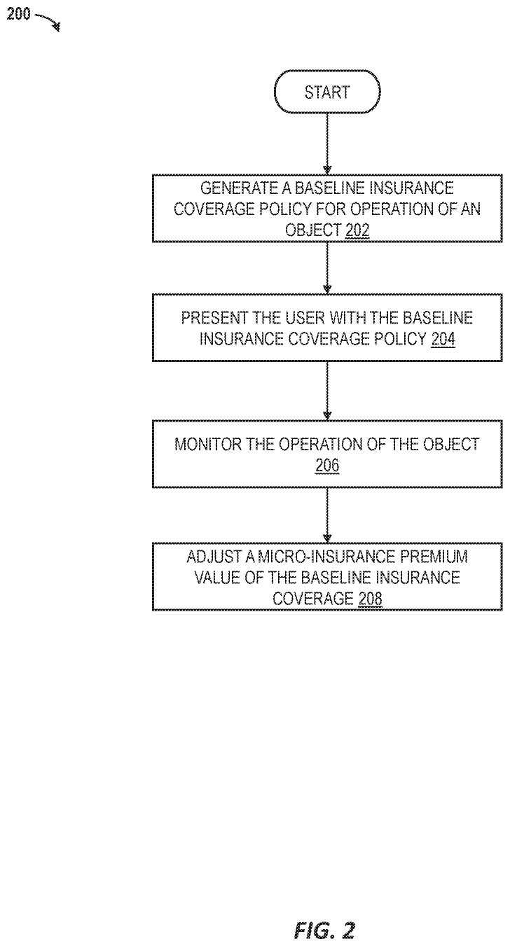

According to the present embodiment, the computer environment 100 may use the micro-insurance module 150 to generate a baseline insurance coverage policy for the operation of an object specific to the user. The micro-insurance method is explained in more detail below with respect to FIG. 2.

Referring now to FIG. 2, an operational flowchart illustrating the exemplary insurance premium determination process 200 used by the micro-insurance module 150 according to at least one embodiment is depicted.

At 202, the micro-insurance module 150 generates a baseline insurance coverage policy for operation of an object. The micro-insurance module 150 may generate the baseline insurance coverage policy (e.g., micro-insurance premium policy) based on an object and/or entity identified by a user. The user may identify the object and/or entity in a micro-insurance user interface.

The micro-insurance user interface may be displayed by the micro-insurance module 150 in at least an internet browser, dedicated software application, and/or as an integration with a third party software application. In an embodiment, the dedicated software application may be an IBM Cloud® Platform-based application which may employ applications, such as, but not limited to IBM Watson® Visual Recognition, IBM Watson® IoT (Internet of Things), Watson Analytics®, and IBM Cloud® Object Storage (IBM Cloud, IBM Watson, and all IBM Cloud-based or Watson-based trademarks are trademarks or registered trademarks of International Business Machines Corporation in the United States, and/or other countries), in improving efficiency of end-to-end claims processing under the baseline insurance coverage policy (e.g., micro-insurance premium policy).

In another embodiment, the third party software application may be a software application operated by an insurance provider and/or the manufacturer of the object. In yet another embodiment, the micro-insurance module 150 may integrate the micro-insurance software with the operation application, such as a drone flight application, such that the heatmap generated as part of the baseline insurance coverage policy may enable the automatic geo-fencing of specific higher risk areas identified within the heatmap which may prevent the object and/or entity being operated by the user from entering, for example, a red-marked heatmap boundary.

The micro-insurance module 150 may receive and/or access data with respect to the object and/or entity identified by the user from at least a knowledge corpus (e.g., database 130), amongst other sources. The knowledge corpus (e.g., database 130) may be comprised of at least data received and/or accessed from the user and/or crowdsourced data relating to the operation of the same and/or similar objects and/or entities by other users. All data received and/or accessed by the micro-insurance module 150 shall not be construed as to violate or encourage the violation of any local, state, federal, or international law with respect to privacy protection. The micro-insurance module 150 may receive consent from the user, the insurance provider, and/or the manufacturer prior to receiving any data. All users may be able to monitor any data being shared and/or revoke access to specific data at any time within the micro-insurance user interface. As will be explained in more detail below, the insurance provider and/or manufacturer may also incentivize data sharing by reducing a premium value of the baseline insurance coverage policy (e.g., micro-insurance premium policy).

While the baseline insurance coverage policy (e.g., micro-insurance premium policy) described below may be specific in certain instances to unmanned aerial vehicles (UAVs) the invention may be applicable more broadly to any object and/or entity which may be operated by a user, such as, but not limited to, farm equipment, industrial machinery, motor vehicles, remote control objects, amongst other user operated objects and/or entities. For example, the user may identify a drone (e.g., the object or entity in this example) in which the user would like to insure through the micro-insurance module 150 within the micro-insurance user interface. The micro-insurance module 150 may access data stored for the drone within the knowledge corpus (e.g., database 130), such as, but not limited to, product configuration, materials user, manufacturing/process parameters, service history, diagnostics data, drone modifications, odometer readings, telematics data, recall campaigns, product details, previous insurance claims, amongst other data stored for the drone within the knowledge corpus (e.g., database 130). As will be explained in more detail below, in an embodiment, the micro-insurance module 150 may generate and/or modify a digital twin for the object identified by the user.

In an embodiment, the micro-insurance module 150 may generate a digital twin based on the object and/or entity identified by the user within the micro-insurance user interface. A digital twin may be a digital representation of at least an object, entity, and/or system that spans the object, entity and/or system's lifecycle. The digital twin may be updated using real time data, and may utilize, at least, simulation, machine learning, and/or reasoning in aiding informed decision making. In this embodiment, the micro-insurance module 150, may utilize the data received to learn the operating actions of the user. The micro-insurance module 150 may simulate potential ambient conditions the object and/or entity may go through during a time period in which the user is to be covered by the baseline insurance coverage policy (e.g., micro-insurance premium policy). In this embodiment, the micro-insurance module 150 may utilize one or more forecasting machine learning models in simulating the performance of the digital twin, such as, but not limited to, a Monte Carlo simulation process. The micro-insurance module 150 may additionally utilize a statistical program such as IBM's SPSS® (SPSS® and all SPSS-based are trademarks or registered trademarks of International Business Machines Corporation in the United States, and/or other countries), or Statistical Product and Service Solution, in optimizing the Monte Carlo simulation process. For example, the micro-insurance module 150 may utilize the one or more simulations described above based on at least, the make and model of a UAV, amount of flight experience of the user operating the particular make and model of the UAV. physical condition of the UAV, crowdsourced UAV controller position mapped to UAV flight data, level of risk associated with a projected travel path of the UAV, visibility factors, weather factors, battery level, number of charge cycles on a battery, and a historical battery discharge curve in generating the baseline insurance coverage policy (e.g., micro-insurance premium policy). Accordingly, the micro-insurance module 150 may perform a plurality of simulations using the digital twin which is digital representation of the object for which the user is receiving insurance coverage. By utilizing the digital twin, the micro-insurance module 150 may be able to simulate the particular capabilities of the object in a plurality of conditions representative of the conditions in which the user may be operating the object which may enable the baseline insurance coverage policy for the operation of the object to be generated specifically to the user, the object, and the conditions in which the object may be operated.

In another embodiment, the micro-insurance module 150 may utilize one or more machine learning methods in generating the baseline insurance coverage policy (e.g., micro-insurance premium policy) for the user. The one or more machine learning methods, may include, but are not limited to including, Reinforcement Learning (RL) methods. The RL methods may emphasize discovery via trial-and-error interactions with a surrounding environment which may be utilized to train an agent to make decisions based on incentives earned in different environmental settings. The agent may learn to optimize its decision-making strategy to maximize the cumulative incentives over time to self-adjust insurance premium values for the baseline insurance coverage policy (e.g., micro-insurance premium policy) and maximize the rewards in different settings. The RL methods utilized by the micro-insurance module 150 may include, but are not limited to including, Q-Learning, Deep Q-Networks (DQN), Actor-Critic, Policy Gradient methods, Proximal Policy Optimization (PPO), Trust Region Policy Optimization (TRPO), and State-Action-Reward-State-Action (SARSA), amongst other RL methods. The one or more RL methods may utilize different methods of learning, such as, but not limited to, a Monte Carlo approach and/or a Temporal Difference Learning approach. The Monte Carlo approach may involve waiting for an episode to reach a terminal state, for example, the user to complete a flight with the UAV, to evaluate the effectiveness of the micro-insurance policy. Accordingly, the Monte Carlo approach may enable better decision making of the agent with each iteration, here, every completed flight. The Temporal Difference learning approach may learn in real-time and not wait until the end of the episode to update the micro-insurance policy, rather the Temporal Difference learning approach may update the micro-insurance value premium iteratively throughout an episode following one or more incremental steps within the episode, for example, one or more episodes within the flight of the UAV. The micro-insurance module 150 may utilize different learning methods based on pre-defined settings which may be manually set by the user within the micro-insurance interface. This may enable the user to have a set micro-insurance premium value prior to an episode and/or a self-adjusting micro-insurance premium value based on one or more episodes within the flight.

At 204, the micro-insurance module 150 presents the user with the baseline insurance coverage policy. The micro-insurance module 150 may present the user with the baseline insurance coverage policy prior to the operation of the object and/or entity. The micro-insurance module 150 may present the user with the baseline insurance coverage policy on an EUD 103 and/or a device utilized by the user in operating the entity for which the baseline insurance coverage policy (e.g., micro-insurance premium policy) covers. The baseline insurance coverage policy (e.g., micro-insurance premium policy) may be comprised of at least a micro-insurance premium value, a time period of coverage, and a heatmap. The micro-insurance module 150 may require the user to acknowledge and/or consent to the terms of the baseline insurance coverage policy prior to the operation of the object and/or entity by the user.

The micro-insurance premium value may be the monetary value of the amount owed by the user to the insurance provider and/or manufacturer of the object for the operation of the object for the time period of coverage. As will be explained in more detail below, the micro-insurance premium value presented to the user prior to the operation of the object and/or entity by the user may be a range of values for which the user may be charged based on at least the data received and/or accessed during the monitoring of the operation of the object and/or entity by the user. The micro-insurance module 150 may utilize a blockchain payment method in charging the micro-insurance premium value to the user. The blockchain payment method could utilize one or more smart contracts in enforcing one or more terms of the baseline insurance coverage policy. The micro-insurance module 150 may generate one or more smart contracts to be agreed to between the user and the insurance provider and/or manufacturer of the object prior to the operation of the object by the user. The one or more smart contracts may be programs stored on a blockchain and/or in the knowledge corpus (e.g., database 130) that executes upon the fulfillment of predetermined conditions. For example, the micro-insurance premium value for the operation of the object may be $10 dollars if the user remains in green zones of the heatmap but include a $5 dollar surcharge per minute spent in orange zones of the heatmap and a $10 dollar surcharge per minute spent in red zones of the heatmap. As will be described in more detail below, in at least step 208, the micro-insurance module 150 may adjust the micro-insurance premium value of the baseline insurance coverage policy (e.g., micro-insurance premium policy) based on at least the data received and/or accessed during the monitoring of the operation of the object and/or entity by the user.

The heatmap may be displayed to the user on the EUD 103 and/or the device utilized by the user in operating the entity for which the baseline insurance coverage policy (e.g., micro-insurance premium policy) covers. The heatmap may be static and/or dynamically change in real time. Whether the heatmap is static and/or dynamically changes may be based on the one or more RL methods of learning described above. For example, if the micro-insurance module 150 utilizes a Monte Carlo learning approach the heatmap displayed to the user on the EUD 103 may be static. On the other hand, if the micro-insurance module 150 utilizes a Temporal Difference learning approach the heatmap displayed to the user on the EUD 103 may dynamically change in real time and/or following the completion of one or more iterative episodes within a flight and/or predetermined increments within the time period of coverage.

The heatmap displayed to the user on the EUD 103 and/or the device utilize by the user in operating the entity may utilize visual cues such as colors, symbols, and/or warnings in communicating information about an operation area to the user. The one or more visual cues may be related to, but are not limited to, hazards, overhead power lines, trees, buildings, object concentrations, valleys, crosswinds, amongst other hazards which may have been derived from the crowdsources data relating to the operation of the same and/or similar objects and/or entities by other users as described in detail above with respect to step 202.

At 206, the micro-insurance module 150 monitors the operation of the object and/or entity. The micro-insurance module 150 may monitor the operation of the object and/or entity utilizing performance feedback and/or additional data received from the object and/or entity and/or additional resources during the time period of the coverage of the baseline insurance coverage policy. The performance feedback may be received directly from any Global Positioning System (GPS), gyroscope, accelerometer, and/or other sensor associated with the object and/or entity.

The micro-insurance module 150 may utilize the performance feedback and/or the additional data received from the object and/or entity and/or additional resources in providing one or more recommendations to the user. The one or more recommendations may be displayed to the user on the EUD 103 and/or the device being utilized in operating the entity and/or object either during the operation of the entity and/or object and/or following the time period of coverage. The one or more recommendations to the user may include incentives and/or other recommendations, such as, but not limited to, recommended learning programs, to the user which may reduce the micro-insurance premium value to the user.

In an embodiment, the one or more recommendations to the user may include classes, certificates, operational training, amongst other programs which the user may complete in order to reduce micro-insurance premium values and/or receive more favorable baseline insurance coverage policies. These programs may include, but are not limited to including, instructional videos, articles, hands-on training exercises, amongst other programs. The progress and/or completion of the programs may be tracked by the micro-insurance module 150 and displayed to the user within a user profile displayed in the micro-insurance user interface. The micro-insurance module 150 may incorporate the programs completed by the user into the determinations made by the one or more forecasting machine learning models and/or reinforcement learning methods described at step 202 in generating the baseline insurance coverage policy. As the user performs future operations of the object and/or entity under the baseline insurance coverage policy the micro-insurance module 150 may recommend specific programs to the user based on at least the performance feedback received. Additionally, as will be explained in more detail below, if the operation of the object and/or entity results in an insurance claim, the performance feedback and/or additional data which affected the flight along with the amount of the claim paid by the user may be collected and stored in the knowledge corpus (e.g., database 130) and utilized in retraining the machine learning models and/or learning methods described above to improve risk assessment for future operations.

The micro-insurance module 150 may receive the performance feedback intermittently throughout the time period of which the micro-insurance premium value covers the object and/or entity and/or at the end of the time period. In an embodiment, the micro-insurance module 150 may utilize the micro-insurance premium value and the performance feedback from the object and/or entity in improving the one or more forecasting machine learning models utilized in simulating the performance of the digital twin. The micro-insurance module 150 may retrain the one or more forecasting machine learning models specifically to the user such that future micro-insurance premium values and/or future baseline insurance coverage policies may be more specific to the object and/or entity identified by the user in the micro-insurance user interface and/or more specific to the user's operation of the object and/or entity such that the micro-insurance module 150 may rely less on the operation of the same and/or similar objects and/or entities by other users amongst other crowdsourcing data in generating baseline insurance coverage policies for the user.

The performance feedback and/or additional data received during the operation may be utilized in updating the heatmap. For example, areas that may be fully covered by the baseline insurance coverage policy may be green within the heatmap, yellow may indicate higher risk areas where an additional premium surcharge map apply, and areas to avoid flying which the insurance provider and/or manufacturer of the object and/or entity does not provide coverage under the baseline insurance coverage policy may be red in the heatmap. In this example, the micro-insurance module 150 may be receiving performance feedback such as battery power of the drone and additional data such as real time weather data. Here, based on at least the battery power of the drone and the real time weather data, the micro-insurance module 150 may adjust the heatmap in real time as additional areas may become high risk or previously high risk areas become lower risk. Additionally, as the battery may reach a certain level of discharge during the flight, the micro-insurance module 150 may notify the user with a return to take-off location notification and a recommended path to ensure that the battery may have enough charge for a return flight.

The performance feedback may also include controller position mapped device response data (CPMDRD). The micro-insurance module 150 may collect CPMDRD based on at least a position of various joysticks and/or controls being utilized by the user on the EUD 103 and/or the device which may be utilized by the user in operating the entity and/or object during the baseline insurance coverage policy (e.g., micro-insurance premium policy). In some embodiments, the CPRMDRD may be crowdsourced from multiple devices utilized by other users in operating similar entities and/or objects under their respective baseline insurance coverage policy (e.g., micro-insurance premium policy). The micro-insurance module 150 may collect and/or receive data from any GPS, gyroscope, accelerometer, and/or other sensor associated with the object and/or entity and associate the data collected and/or received with the positions of various joysticks and/or controls being utilized by the user during the operation of the object and/or entity. Accordingly, the micro-insurance module 150 may analyze a deviation of the data from typical responses to controller inputs which may enable the micro-insurance module 150 to define a real-time diagnostic score. For example, a Controller 1 is moved about halfway in the y axis (e.g., 0.5 controller input), which may result in an acceleration of Object 1 at +1.0 meters/second. If this matches the manufacturer specifications the real-time diagnostic score determined by the micro-insurance module 150 may be 100. Continuing with this example, if at a later time, the micro-insurance module 150 that Object 1 and/or a similar make and/or model detects that the halfway in the y axis (e.g., 0.5 controller input) corresponds to an acceleration of +0.8 meters/second, then the real-time diagnostic score determined by the micro-insurance module 150 may be 80. In an embodiment, the real-time diagnostic scores for a plurality of performance factors may be utilized by the insurance provider and/or manufacturer in at least, adjusting a micro-insurance premium value, a determination on whether to offer a baseline insurance coverage policy (e.g., micro-insurance premium policy), providing one or more recommendations, such as, replacement parts from the manufacturer, amongst other determinations. Continuing with the example above, the micro-insurance module 150 may require a user pay higher micro-insurance premium values or require the object be serviced based on a condition of the insurance provider and/or manufacturer that insurance coverage may be limited for acceleration real-time diagnostic scores under 90 and/or another predetermined threshold. Additionally, the heatmap may be updated according to the real-time diagnostic scores and/or capabilities of the object such that additional areas within the map may be restricted based on the capabilities of the object.

At 208, the micro-insurance module 150 may adjust a micro-insurance premium value of the baseline insurance coverage policy. The micro-insurance module 150 may adjust the micro-insurance premium value of the baseline insurance coverage policy (e.g., micro-insurance premium policy) based on the data received and/or accessed during the monitoring of the operation of the object and/or entity by the user.

As described in detail above with respect to at least steps 204 and 206, the baseline insurance coverage policy (e.g., micro-insurance premium policy) may be comprised of at least a micro-insurance premium value, a time period of coverage, and a heatmap. The micro-insurance module 150 may adjust the micro-insurance premium value within the range of values presented to the user prior to the operation of the object and/or entity within the baseline insurance coverage policy (e.g., micro-insurance premium policy).

The micro-insurance module 150 may present an adjusted micro-insurance premium value to the user in the micro-insurance user interface prior to charging the user and/or provide a summary of the adjusted micro-insurance premium value to the user. The micro-insurance module 150 may either present the adjusted micro-insurance premium value to the user and/or provide the summary of the adjusted micro-insurance premium value charged to the user based on settings maintained within the user profile of the user. The summary provided to the user in the micro-insurance user interface may be an amount which has been charged to the user utilizing the blockchain payment method based on at least one or more smart contracts automatically executed during the operation of the object of the user based on the data received and/or accessed at step 206.

The micro-insurance module 150 may enable the user to reduce the adjusted micro-insurance premium value by completing the one or more programs described at step 206, such as, but not limited to include classes, certificates, operational training, amongst other programs. For example, the micro-insurance module 150 may enable the user to watch a recording of the completed operation of the object and/or entity. The micro-insurance module 150 may display this recording of the completed operation to the user in the micro-insurance user interface which may include answerable prompts corresponding to actions taken by the user which may instruct the user on how to make more informed decisions in similar situations in future operations of the object and/or entity.

In an embodiment, the micro-insurance module 150 may adjust the micro-insurance premium value of the baseline insurance coverage as well as other incentives of the baseline insurance coverage (e.g., micro-insurance premium policy) by retraining the agent described at step 202 utilized in generating the baseline insurance coverage policy. The micro-insurance module 150 may utilize the data received during the monitoring of the operation of the object by the user as additional input for the Reinforcement Learning (RL) methods to self-adjust the micro-insurance premium values and incentives specifically for the user such that the baseline insurance coverage policies generated for future operations of the object by the user are comprised of smart contracts, incentives, and/or micro-insurance premium value ranges specific to the user.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for insurance premium determinations, the method comprising:
generating a baseline insurance coverage policy for the operation of an object;
presenting a user with the baseline insurance coverage policy prior to an operation of the object; and
monitoring the operation of the object by the user.

2. The method of claim 1, wherein the baseline insurance coverage policy is comprised of at least a micro-insurance premium value, a time period of coverage, and a heatmap.

3. The method of claim 2, further comprising:
adjusting the micro-insurance premium value of the baseline insurance coverage policy based on data received during the monitoring of the operation of the object by the user.

4. The method of claim 3, wherein the micro-insurance premium value is adjusted utilizing one or more smart contracts.

5. The method of claim 1, wherein the user is presented with the baseline insurance coverage policy in a micro-insurance user interface, wherein the micro-insurance user interface includes a user profile of the user, and wherein the user profile includes a record of one or more recommended learning programs previously completed by the user.

6. The method of claim 1, wherein the baseline insurance coverage policy is generated by an agent trained using one or more reinforcement learning methods.

7. The method of claim 6, wherein the agent is retrained using the one or more reinforcement learning methods based on data received during the monitoring of the operation of the object by the user.

8. A computer system for insurance premium determinations, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a baseline insurance coverage policy for the operation of an object;
presenting a user with the baseline insurance coverage policy prior to an operation of the object; and
monitoring the operation of the object by the user.

9. The computer system of claim 8, wherein the baseline insurance coverage policy is comprised of at least a micro-insurance premium value, a time period of coverage, and a heatmap.

10. The computer system of claim 9, further comprising:
program instructions, stored on at least one of the one or more computer-readable storage media for execution by at least one of the one or more processors via at least one of the one or more memories, to adjust the micro-insurance premium value of the baseline insurance coverage policy based on data received during the monitoring of the operation of the object by the user.

11. The computer system of claim 10, wherein the micro-insurance premium value is adjusted utilizing one or more smart contracts.

12. The computer system of claim 8, wherein the user is presented with the baseline insurance coverage policy in a micro-insurance user interface, wherein the micro-insurance user interface includes a user profile of the user, and wherein the user profile includes a record of one or more recommended learning programs previously completed by the user.

13. The computer system of claim 8, wherein the baseline insurance coverage policy is generated by an agent trained using one or more reinforcement learning methods.

14. The computer system of claim 13, wherein the agent is retrained using the one or more reinforcement learning methods based on data received during the monitoring of the operation of the object by the user.

15. A computer program product for insurance premium determinations, comprising:
one or more computer readable storage media, and program instructions collectively stored on the one or more computer readable storage media, the program instructions comprising:
generating a baseline insurance coverage policy for the operation of an object;
presenting a user with the baseline insurance coverage policy prior to an operation of the object; and
monitoring the operation of the object by the user.

16. The computer program product of claim 15, wherein the baseline insurance coverage policy is comprised of at least a micro-insurance premium value, a time period of coverage, and a heatmap.

17. The computer program product of claim 16, further comprising:
program instructions, stored on at least one of the one or more computer-readable storage media, to adjust the micro-insurance premium value of the baseline insurance coverage policy based on data received during the monitoring of the operation of the object by the user.

18. The computer program product of claim 17, wherein the micro-insurance premium value is adjusted utilizing one or more smart contracts.

19. The computer program product of claim 15, wherein the user is presented with the baseline insurance coverage policy in a micro-insurance user interface, wherein the micro-insurance user interface includes a user profile of the user, and wherein the user profile includes a record of one or more recommended learning programs previously completed by the user.

20. The computer program product of claim 15, wherein the baseline insurance coverage policy is generated by an agent trained using one or more reinforcement learning methods.
